(19) United States
(12) Patent Application Publication
(10) Pub. No.: US 2010/0065381 A1
(43) Pub. Date: Mar. 18, 2010

(54) SWAY MITIGATION IN AN ELEVATOR SYSTEM

(76) Inventors: Randall Keith Roberts, Hebron, CT (US); Mark R. Gurvich, Middletown, CT (US); John M. Milton-Benoit, West Suffield, CT (US)

Correspondence Address: CARLSON GASKEY & OLDS, 400 W MAPLE STE 350, BIRMINGHAM, MI, 48009, US

(21) Appl. No.: 12/447,303

(22) PCT Filed: Dec. 20, 2006
(86) PCT No.: PCT/US06/62352

§ 371 Date: Apr. 27, 2009

(51) Int. Cl. B66B 7/06; B66B 11/02; B66B 7/00

(52) U.S. Cl. 187/401; 187/414; 187/404

(57) ABSTRACT

An elevator system (20) includes an elongated member (30, 32, 34) that may sway under certain conditions. At least one mitigation member (80) is strategically positioned in a mitigation position corresponding to a location of an anti-node (48, 54, 56, 66, 68, 70) of the elongated member (30, 32, 34) for a given sway condition. In a disclosed example, a controller (38) deploys a mitigation member (80) at a mitigation position for a given sway condition determined by the controller (38). In one example, a plurality of sway mitigation members (80) are strategically positioned at various mitigation positions within a hoistway (26). In another example, a sway mitigation member (80) is selectively moveable within a hoistway (26) between a plurality of mitigation positions.

### BACKGROUND

1. Field of the Invention

This invention generally relates to elevator systems. More particularly, this invention relates to minimizing sway of one or more vertical members in an elevator system.

2. Description of the Related Art

Many elevator systems include an elevator car and counterweight that are suspended within a hoistway by roping comprising one or more load bearing members. Typically, a plurality of ropes, cables or belts are used for supporting the weight of the elevator car and counterweight and for moving the elevator car to desired positions within the hoistway. The load bearing members are typically routed about several sheaves according to a desired roping arrangement. It is desirable to maintain the load bearing members in an expected orientation based upon the roping configuration.

There are other vertically extending members within many elevator systems. Tie down compensation typically relies upon a chain or roping beneath an elevator car and counterweight. Elevator systems typically also include a traveling cable that provides power and signal communication between components associated with the elevator car and a fixed location relative to the hoistway.

There are conditions where one or more of the vertically extending members such as the load bearing member, tie down compensation member or traveling cable may begin to sway within an elevator hoistway. This is most prominent in high rise buildings where an amount of building sway is typically larger compared to shorter buildings and when the frequency of the building sway is an integer multiple of the natural frequency of a vertically extending member within the hoistway. There are known drawbacks associated with sway conditions.

Various proposals have been made for mitigating or minimizing sway of a vertically extending member within a hoistway. One example approach includes using a swing arm as a mechanical device for inhibiting sway of a load bearing member, for example. U.S. Pat. No. 5,947,232 shows such a device. Another device of this type is shown in U.S. Pat. No. 5,103,937.

Another approach has been to associate a follower car with an elevator car. The follower car is effectively suspended beneath the elevator car and is positioned at the midpoint between the elevator car and a bottom of a hoistway for sway mitigation purposes. A significant drawback associated with this approach is that it introduces additional components and expense into an elevator system. In addition to the follower car and its associated components, the size of the elevator pit must be larger than is otherwise required, which takes up additional real estate space or introduces additional costs or complexities in designing and building the elevator shaft. Additionally, follower cars have only been considered to mitigate sway of compensation ropes and they introduce additional potential complications into an elevator system.

Another approach includes controlling the position of an elevator car and the speed with which the car moves within a hoistway for minimizing the sway. It is known how to identify particular elevator car positions within a hoistway corresponding to particular building sway frequencies that will more effectively excite the vertically extending members. One approach includes minimizing the amount of time an elevator car is allowed to remain at such a so-called critical position when conditions conducive to sway are present.

While the previous approaches have proven useful, those skilled in the art are always striving to make improvements. This invention includes an advanced technique that provides enhanced sway mitigation.

### SUMMARY

An exemplary method of controlling sway of an elongated member in an elevator hoistway includes determining at least one location within the hoistway corresponding to an anti-node of the elongated member if at least one condition conducive to sway exists. A sway mitigation member is positioned at a mitigation position within a selected range of the determined location corresponding to the anti-node at least when the condition conducive to sway exists.

One example includes permanently positioning the sway mitigation member at the mitigation position. Another example includes moving the sway mitigation member from another position within the hoistway to the mitigation position if the condition conducive to sway exists.

In one example, the sway mitigation member is supported for movement along a stationary surface within the hoistway. In another example, the sway mitigation member is supported on an elevator car or a counterweight that is moved within the hoistway to appropriately position the sway mitigation member.

An exemplary elevator system includes at least one elongated member within an elevator hoistway. The elongated member has at least one anti-node at a determined location within the hoistway if at least one condition exists that is conducive to sway of the elongated member. At least one sway mitigation member is positioned at a mitigation position within a selected range of the location corresponding to the anti-node at least when the condition conducive to sway exists.

In one example, the sway mitigation member remains at an essentially fixed position within a hoistway. In another example, the sway mitigation member is selectively moveable within the hoistway to a desired mitigation position corresponding to a current condition.

Strategically positioning a sway mitigation member at a position within a hoistway corresponding to a location of an anti-node of an elongated member within the hoistway facilitates enhanced sway mitigation. In one example, a technique of controlling the position, speed or both of the elevator car is combined with the strategic positioning of the sway mitigation member.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrated selected portions of an elevator system that may incorporate an example embodiment of this invention.

FIG. 2 schematically illustrates sway behavior of an elongated member within an elevator hoistway.

FIG. 3 schematically illustrates one example approach of sway mitigation designed according to an example embodiment of this invention.

FIG. 4 schematically illustrates another example approach.

FIG. 5 schematically illustrates another example approach.

### DETAILED DESCRIPTION

Example embodiments of this invention provide sway mitigation within an elevator hoistway to control the amount of sway of one or more elongated members such as a load bearing member (e.g., an elevator rope or belt), a tie down compensation member or a traveling cable, for example. Strategically positioning a sway mitigation member at a position within a hoistway corresponding to an anti-node of the elongated member for a given potential sway condition provides enhanced sway mitigation compared to previous approaches.

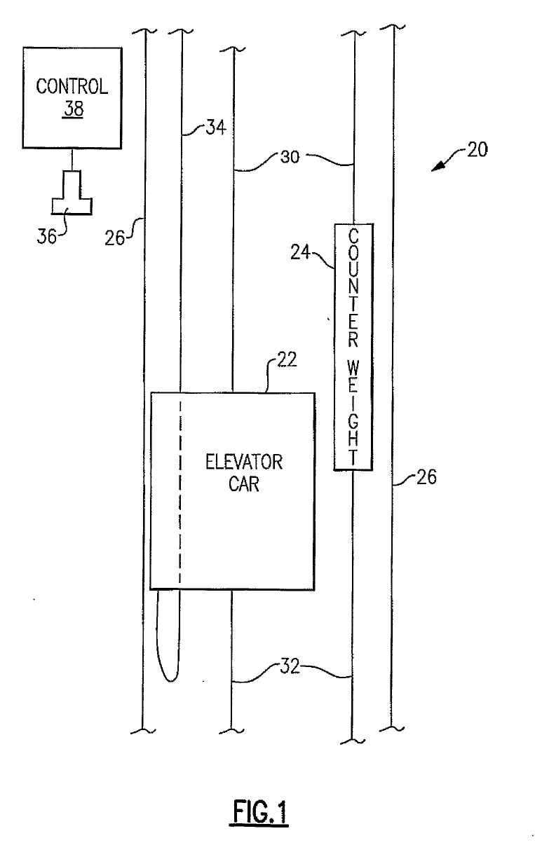

FIG. 1 schematically shows selected portions of an elevator system 20. An elevator car 22 and counterweight 24 are moveable within a hoistway 26 in a known manner. The elevator car 22 and counterweight 24 are supported by a load bearing assembly including roping or belts that support the weight of the elevator car 22 and counterweight 24 and provide for moving them in a known manner. An example load bearing member 30 is shown in FIG. 1. In the illustrated example, a tie down compensation member 32 is associated with the elevator car 22 and the counterweight 24 to provide tie down compensation in a known manner. A traveling cable 34 provides for communicating electrical power and signals between components associated with the elevator car 22 and at least one other device typically located in a fixed position relative to the hoistway 26.

Each of the load bearing member 30, tie down compensation member 32 and traveling cable 34 is an elongated vertical member within the hoistway 26. Any one or more of the elongated vertical members 30, 32, 34 may begin to sway within the hoistway 26 if appropriate conditions conducive to sway exist. Building sway is known to induce sway of an elongated vertical member within a hoistway especially when the frequency of the building sway is an integer multiple of a natural frequency of the elongated member.

The example of FIG. 1 includes a sensor 36 that operates in a known manner to provide an indication of any existing building sway. In one example, the sensor 36 is a pendulum-type sensor. Another example includes a wind anemometer. A controller 38 communicates with the sensor 36 and determines whether a condition exists that is conducive to sway of at least one of the elongated vertical members within the hoistway 26. The controller 38 is programmed to respond to such a condition by controlling the operation of at least one sway mitigation member as will be described below. In one example, the controller 38 is also responsible for controlling the position, speed or both of the elevator car 22 in an manner that is intended to minimize an amount of sway. In one example, the controller 38 uses known elevator car position and speed control techniques for this purpose. The controller 38 in one example also uses information regarding a load on the elevator car 22.

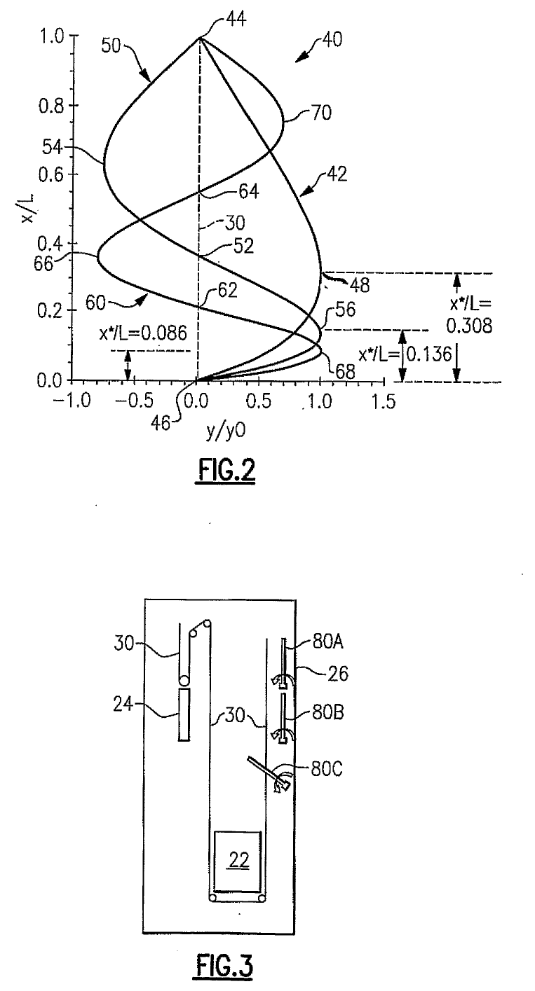

FIG. 2 includes a graphical plot 40 that schematically illustrates sway behavior of an example elongated member within a hoistway. For purposes of discussion, the load bearing member 30 will be considered as an example elongated member for the remainder of this description. FIG. 2 includes a static desired orientation of the load bearing member 30 shown in phantom as a vertical line. This orientation corresponds to a desired orientation of the load bearing member 30 based upon a selected roping arrangement, for example.

In FIG. 2, L represents a length of an example load bearing member 30 and x represents a distance along the vertical axis. Y is a lateral distance along the horizontal axis and y0 is the maximal sway in a direction along the horizontal axis.

Several conditions may exist that will be conducive to the load bearing member 30 swaying within the hoistway 26. One sway condition is shown at 42. When the frequency of building movement or sway corresponds to the natural frequency of the load bearing member 30 (given a current position of the elevator car, for example) an N=1 mode of sway as schematically shown at 42 may exist. In this condition, the load bearing member 30 has a node at 44 and at 46, which correspond in one example to the connection between the load bearing member and the elevator car and an interface between the load bearing member and a traction sheave near opposite ends of the portion of the load bearing member 30 shown in FIG. 2. Between the two nodes 44 and 46 is an anti-node at a location 48 (x*/L). The anti-node corresponds to the largest displacement of the load bearing member 30 from the desired position shown in phantom in FIG. 2. The anti-node 48 is at a location corresponding to a greatest amplitude of movement in a horizontal or lateral direction of the load bearing member 30 in the N=1 mode of sway.

The example conditions schematically represented in FIG. 2 are for a particular case and depend on the elongated member tension, mass per unit length, and member length. For example, the distance x* corresponding to a node location along the length L represents one load condition. Other load conditions may result in values of x*/L that are different than those in the Figure. In one example, the controller 38 uses information regarding a current load on the elevator car 22 for purposes of determining the location of the anti-node(s) for a given mode of sway.

An example embodiment includes strategically positioning a sway mitigation member at a mitigation position within a selected range of a location of an anti-node of an elongated vertical member such as the load bearing member 30. In some examples, the sway mitigation member will be located at a mitigation position corresponding as closely as possible to the expected anti-node location for a given condition. In another example, an acceptable range of mitigation positions including the location of the anti-node may be used. In the case of an N=1 mode of sway, there may be considerable latitude in the desired position of the sway mitigation member, for example. Provided that the sway mitigation member is strategically positioned close enough to the location of the anti-node, the benefit of the example approach can be achieved.

As can be appreciated from the illustration, the location of the anti-node 48 is not at the midpoint of the length of the load bearing member 30 shown in FIG. 2. This is because the tension on the load bearing member 30 is not constant along its length but decreases in magnitude from top to bottom because of the per unit length weight of the load bearing member 30. One shortcoming of previous attempts at sway mitigation has been to position a sway mitigation member at the midpoint of the vertical length of a load bearing member. The thinking behind that approach was to effectively reduce the effective length of the load bearing member in half to change the effective natural frequency. Under various conditions, such a position of a sway mitigation member will not provide the desired effect.

Another sway condition is shown at 50. In this condition, the load bearing member 30 has nodes at 44, 46 and 52. The nodes correspond to positions of the load bearing member 30 that are coincident with the desired orientation shown in phantom. In this N=2 mode, the building frequency of movement is twice that of the natural frequency of the load bearing member 30. Anti-nodes exist at 54 and 56 in this condition. As can be appreciated from the illustration, the node 52 is not at the mid point of the length of the load bearing member 30 and the anti-nodes 54 and 56 are not symmetrically positioned relative to the node 52 nor the mid-point along the length of the load bearing member 30. Again, this type of configuration is due to the tension on the load bearing member 30 and the weight of the load bearing member 30 itself under the illustrated conditions.

A third sway condition is shown at 60. In one example this is an N=3 mode where the building movement frequency is three times the natural frequency of the load bearing member 30. In this condition, the load bearing member 30 has nodes at 44, 46, 62 and 64. Anti-nodes are at 66, 68 and 70.

Determining the locations of the anti-nodes in one example includes solving an equation that is, or a system of equations that are, indicative of the response of an elongated vertical member in a hoistway to building sway displacements. One example uses known behaviors of suspended vertical members and incorporates information corresponding to how elevator system components can be fitted to such a model. Given this description, those skilled in the art will realize how best to determine the locations of the anti-nodes for a given elongated vertical member in a particular elevator system for any number of order modes for any elevator car vertical location.

Positioning a sway mitigation member in a mitigation position in one example includes positioning the sway mitigation member within a selected range of an anti-node location. The acceptable range in one example varies depending on the current sway condition. Referring to FIG. 2, for example, when a sway mitigation member is positioned in a mitigation position corresponding to the location of the anti-node 48, a wider range will be useful compared to a range that will be useful for a mitigation position corresponding to the location of the anti-node 68. As can be appreciated from the illustration, a particular distance from the exact location of the anti-node 48 may still position the mitigation member in a manner that is effective for controlling sway of the load bearing member 30. That same distance from the location of the anti-node 68 may effectively position the sway mitigation member at a location corresponding to the node 62, which would be ineffective under some circumstances for maximum possible sway control. Given this description, those skilled in the art will realize how to set desired limits on an acceptable range of distance between a mitigation position and an anti-node location to meet the needs of their particular situation.

In the example of FIG. 2, it may be possible to position a mitigation member at a single mitigation position that is effective for addressing the anti-node locations corresponding to the anti-nodes 56 and 68. If the distance between the anti-nodes 56 and 68 is small enough and the mitigation member is appropriately sized, a single mitigation position may be effective for addressing the anti-node 56 under one condition or the anti-node 68 under a different sway condition.

Strategically positioning a sway mitigation member at a mitigation position corresponding to a location of an anti-node provides enhanced sway mitigation compared to previous approaches. By minimizing the amount of movement of an elongated vertical member at the position where the greatest amount of such movements would otherwise occur has benefits. There are several example approaches to strategically positioning a sway mitigation member in this manner that are consistent with an embodiment of this invention.

FIG. 3 schematically illustrates one example approach. In this example, at least one sway mitigation member 80 is supported in a fixed position within the hoistway 26 so that when the sway mitigation member 80 is deployed, it is in a mitigation position corresponding to the location of an expected anti-node of the load bearing member 30. In one example, a sway mitigation member consistent with the teachings of U.S. Pat. No. 5,947,232 is supported within the hoistway 26 such that it can be deployed for purposes of sway mitigation. The sway mitigation member 80 may be a swing arm, snubber or other mechanical device that limits lateral motion, for example.

The example of FIG. 3 includes a plurality of sway mitigation members at various locations within the hoistway 26. The sway mitigation member 80A may be, for example, positioned at a position within the hoistway 26 corresponding to the location of the anti-node 70 shown in FIG. 2. The sway mitigation member 80B may be positioned in a mitigation position corresponding to the location of the anti-node 48. The sway mitigation member 80C may be positioned in a mitigation position corresponding to the anti-node 56.

In one example, the controller 38 determines what type of sway-conducive condition exists. The controller 38 is programmed to use such information and information regarding predetermined locations of one or more anti-nodes of the load bearing member 30 under such a condition for determining which of the sway mitigation members in the example of FIG. 3 to deploy. In other words, the controller 38 utilizes information from the sensor 36 and predetermined information regarding the expected locations of the anti-nodes for a given sway condition for purposes of determining the locations at which a sway mitigation member should be deployed. The location information in one example is specific for each of a plurality of different load conditions. In some examples, only one sway mitigation member will be deployed at any given time. In other examples, multiple sway mitigation members may be used simultaneously at one sway mitigation position or multiple sway mitigation positions, depending on the particular condition.

In one example, in addition to deploying one or more sway mitigation members, the controller 38 controls the position, speed or both of the elevator car 22 to further minimize potential sway. In one example, whenever the determined building sway frequency is within about 10% of the natural frequency of the load bearing member 30, for particular locations of the elevator car 22 within the hoistway 26, these locations are considered so-called critical zones. In one example, the controller 38 minimizes the amount of time the elevator car 22 remains in a critical zone and reduces a speed at which the elevator car 22 moves within the hoistway 26 compared to a normal, contract speed. For example, the elevator car 22 will not be allowed to remain parked at a landing corresponding to a critical zone for more than a preset time if a condition conductive to sway exists. Instead, the elevator car 22 moves to another location

In one example, the controller 38 includes a database such as a look up table that has information corresponding to various conditions conducive to sway, corresponding critical zone locations of an elevator car, locations of anti-nodes and corresponding desired mitigation positions of a mitigation member. The controller 38 uses this information for determining how best to implement speed and position control of the elevator car and at least one sway mitigation member to minimize or completely inhibit sway. In one example, the controller 38 includes such information for each of a load bearing member 30, a tie down compensation member 32 and a traveling cable 34.

FIG. 4 schematically illustrates another example approach. In this example, the sway mitigation member 80 is supported for vertical movement along a vertical surface such as one of the walls in the hoistway 26. The sway mitigation member 80 in this example is controlled by the controller 38 to move as schematically shown at 82 among a plurality of mitigation positions, each of which may correspond to one or more anti-node locations within the hoistway 26.

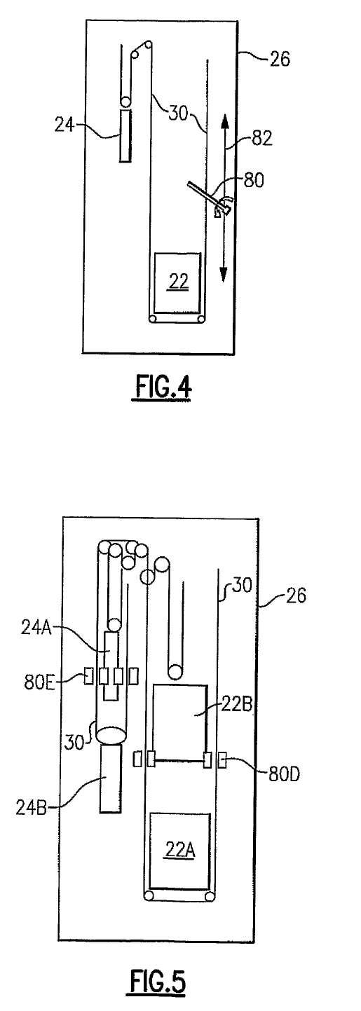

FIG. 5 schematically illustrates another example approach. This example includes multiple elevator cars and counterweights within a hoistway 26. In this example, an elevator car 22B includes sway mitigation members 80D that are useful for minimizing sway of the load bearing member 30 that supports the elevator car 22A. The controller 38 in such an example strategically controls the position of the elevator car 22B to position the sway mitigation members 80D in a mitigation position for a given condition.

The example of FIG. 5 also includes sway mitigation members 80E associated with the counterweight 24A. In such an example, the sway mitigation members 80E are useful for minimizing sway of the load bearing member 30 supporting the counterweight 24B.

In the case of two cars 22A, 22B, if one of the cars 22A were parked at a lower lobby such that the vertically extending members thereof were suspended in a critical zone, the other car 22B could be controlled so as to serve in a sway mitigation capacity at an anti-node of the car 22A. Similarly, if one of the cars 22B were parked at an upper lobby such that its load bearing members were suspended in a critical zone, the other car 22A could be controlled so as to serve in a sway mitigation capacity at an anti-node of the car 22B.

Although not illustrated in FIG. 5, additional sway mitigation members may be associated with either of the elevator cars 22A, 22B or the counterweights 24A, 24B for purposes of controlling sway of tie down compensation members traveling cables or other elongated vertical members within the elevator system of the example of FIG. 5.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of controlling sway of an elongated member in an elevator hoistway, comprising the steps of:
determining at least one location within the hoistway corresponding to an anti-node of the elongated member when at least one condition conducive to sway exists; and
positioning a sway mitigation member at a mitigation position within a selected range of the determined location at least when the at least one condition exists.

2. The method of claim 1, comprising
permanently positioning the sway mitigation member at the mitigation position; and
selectively deploying the sway mitigation member for controlling sway of the elongated member.

3. The method of claim 1, comprising
moving the sway mitigation member from another position within the hoistway to the mitigation position if the at least one condition exists.

4. The method of claim 3, comprising
supporting the sway mitigation member for movement along a stationary surface within the hoistway.

5. The method of claim 3, comprising
supporting the sway mitigation member on at least one of an elevator car or a counterweight; and
moving the at least one of the elevator car or the counterweight to a position that places the sway mitigation member in the mitigation position if the at least one condition exists.

6. The method of claim 1, comprising
determining a plurality of locations each corresponding to an anti-node of the elongated member if one of a corresponding plurality of conditions conducive to sway exists; and
deploying the sway mitigation member at a selected mitigation position within a selected range of one of the determined locations if a corresponding one of the conditions exists.

7. The method of claim 6, comprising
determining which of the conditions exists; and
moving the sway mitigation member to the corresponding mitigation position.

8. The method of claim 6, comprising
positioning a sway mitigation member at a mitigation position corresponding to each of the determined plurality of locations; and
selecting a corresponding one of the sway mitigation members for the deploying if one of the plurality of conditions exists.

9. The method of claim 1, comprising
determining the at least one location as a function of elevator car position in the hoistway; and
controlling at least one of a desired elevator car position or speed for minimizing an amount of possible sway if the at least one condition exists.

10. The method of claim 1, wherein the elongated member comprises at least one of
an elevator load bearing member;
an elevator compensation member; or
a traveling cable.

11. The method of claim 1, comprising
determining at least one critical zone within the hoistway corresponding to the at least one condition; and
moving an elevator car out of the at least one critical zone if the at least one condition exists.

12. The method of claim 1, comprising
reducing a speed of movement of an elevator car in the hoistway if the at least one condition exists.

13. The method of claim 1, wherein the elongated member is associated with a first elevator car, the method comprising
moving a second elevator car to the anti-node of the elongated member, when the at least one condition conducive to sway exists.

14. An elevator system, comprising:
at least one elongated member in a hoistway, the elongated member having an anti-node at a predetermined location if at least one condition exists that is conducive to sway of the elongated member; and
a sway mitigation member at a mitigation position in the hoistway within a selected range of the predetermined location corresponding to the anti-node at least when the condition conducive to sway exists.

15. The system of claim 14, wherein the sway mitigation member is permanently positioned near the mitigation position.

16. The system of claim 14, wherein the sway mitigation member is selectively moveable from another position within the hoistway to the mitigation position if the condition exists.

17. The system of claim 16, wherein the sway mitigation member is moveable along a stationary surface within the hoistway.

18. The system of claim 16, comprising
a plurality of elevator cars and associated counterweights within the hoistway; and
wherein the sway mitigation member is supported for movement with at least one of the elevator cars or counterweights such that the corresponding elevator car or counterweight is moveable into a position that places the sway mitigation member in the mitigation position.

19. The system of claim 14, comprising a plurality of sway mitigation members each at a mitigation position corresponding to a different location of an anti-node.

20. The system of claim 19, comprising
a controller that is configured to: (a) determine a current condition and a corresponding location of one of the anti-nodes; and (b) deploy a selected one of the mitigation members at a corresponding mitigation position.

21. The system of claim 14, comprising
a controller that is configured to: (a) determine the at least one location corresponding to the anti-node as a function of elevator car position in the hoistway; and (b) control at least one of a desired elevator car position or speed for minimizing an amount of possible sway.

22. The system of claim 21, wherein the controller is configured to move the elevator car out of a critical zone in the hoistway if the at least one condition exists.

23. The system of claim 21, wherein the controller is configured to reduce a speed of movement of the elevator car if the at least one condition exists.

24. The system of claim 14, wherein the elongated member comprises at least one of
an elevator load bearing member;
an elevator compensation member; or
a traveling cable.

25. The system of claim 14, comprising a sensor that is configured to provide an indication when the at least one condition exists.
